(19) United States
(12) Patent Application Publication
(10) Pub. No.: US 2019/0065020 A1
(43) Pub. Date: Feb. 28, 2019

(54) GUIDED MENU FOR A GRAPHICAL USER INTERFACE

(71) Applicant: Ugochukwu Okafor, South Ozone Park, NY (US)

(72) Inventor: Ugochukwu Okafor, South Ozone Park, NY (US)

(21) Appl. No.: 16/109,429

(22) Filed: Aug. 22, 2018

Related U.S. Application Data
(60) Provisional application No. 62/549,339, filed on Aug. 23, 2017.

(51) Int. Cl. G06F 3/0484; G06F 17/30; G06F 3/0482; G06F 3/0481

(52) U.S. Cl. CPC G06F 3/0484; G06F 3/04817; G06F 3/0482; G06F 17/30873

(57) ABSTRACT

A control system is disclosed. The control system has a navigation control module, comprising computer-executable code stored in non-volatile memory, a processor, and a graphical user interface having a graphical user interface display. The navigation control module, the processor, and the graphical user interface are configured to display one or more graphical interactive user interface objects on the graphical user interface display, display a multi-functional control object on the graphical user interface display, and change the multi-functional control object from a first state to a second state, which is different from the first state, based on user input provided to the graphical user interface. The multi-functional control object is moveable on the graphical user interface display based on user input provided to the graphical user interface.

### RELATED APPLICATIONS

This application claims the benefit of U.S. Provisional Patent Application Ser. No. 62/549,339 filed Aug. 23, 2017, which is hereby incorporated by reference in its entirety.

### TECHNICAL FIELD

Various embodiments relate generally to graphical user interfaces.

### BACKGROUND

User interfaces enable human user interaction with computers. User interfaces may provide various types of interaction. For example, some user interfaces may be based on textual commands and responses through a terminal application. In an illustrative example, some computer application user interfaces may be adapted to visually interact with a user. For example, some user interfaces may present visually perceptible display elements to a user. A user interface based on visually perceptible display elements may be known as a Graphical User Interface (GUI).

The visual appearance of some Graphical User Interface display elements may be adapted in real time to correspond with the state of an associated application. For example, a graphical user interface may provide buttons, menus, or lists representing transaction options offered to a user. Some graphical user interfaces display user-selectable visually perceptible elements. For example, some graphical user interface display elements may be selected or manipulated by a user to provide information or responses to the associated application. For example, users may be able to interact with some graphical user interface elements by clicking or scrolling an interface element to indicate a user choice. In an illustrative example, a graphical user interface displaying transaction options to a user may change color, design, or content of visually perceptible user interface elements in response to a user choosing a transaction.

Some graphical user interfaces use substantial display area. In some applications of graphical user interfaces, the display area may be limited. Displaying a graphical user interface in limited display area may result in the graphical user interface shrinking or zooming out, leading to reduced visibility of graphical user interface elements. In some graphical user interfaces, a small display area may result in a user having to scroll the interface display to access important buttons or menus. Limited display area for some graphical user interfaces may reduce a user's satisfaction with the application experience, restrict the user's access to application functionality, or make user interface navigation more difficult. For example, conventional designs such as hamburger menus, sidebar menus, dropdown menus, or static footer menus use excessive screen space and are not moveable from a static location.

The exemplary disclosed system and method are directed to overcoming one or more of the shortcomings set forth above and/or other deficiencies in existing technology.

### SUMMARY OF THE DISCLOSURE

In one exemplary aspect, the present disclosure is directed to a control system. The control system includes a navigation control module, comprising computer-executable code stored in non-volatile memory, a processor, and a graphical user interface having a graphical user interface display. The navigation control module, the processor, and the graphical user interface are configured to display one or more graphical interactive user interface objects on the graphical user interface display, display a multi-functional control object on the graphical user interface display, and change the multi-functional control object from a first state to a second state, which is different from the first state, based on user input provided to the graphical user interface. The multi-functional control object is moveable on the graphical user interface display based on user input provided to the graphical user interface. The multi-functional control object is an all-in-one multi-functional control object configured to control substantially all user navigation of the one or more graphical interactive user interface objects.

In another aspect, the present disclosure is directed to a method. The method includes displaying one or more graphical interactive user interface objects on a graphical user interface display, displaying a multi-functional control object on the graphical user interface display, changing the multi-functional control object from a first state to a second state, which is different from the first state, based on user input provided to the graphical user interface, and moving the multi-functional control object on the graphical user interface display based on user input provided to the graphical user interface. The multi-functional control object is an all-in-one multi-functional control object that controls substantially all user navigation of the one or more graphical interactive user interface objects.

### BRIEF DESCRIPTION OF THE DRAWINGS

FIG. 1 depicts an exemplary web page interface to an exemplary web service offering commercial marketing service opportunities;

FIG. 2 depicts an exemplary web page interface displaying an exemplary phase of the user's marketing service transaction;

FIG. 3 depicts an exemplary web page interface displaying an exemplary phase of the user's marketing service transaction;

FIG. 4 depicts an exemplary web page interface displaying an exemplary phase of the user's marketing service transaction;

FIG. 5 depicts an exemplary web page interface displaying an exemplary phase of the user's marketing service transaction;

FIG. 6 depicts an exemplary web page interface displaying an exemplary phase of the user's marketing service transaction;

FIG. 7 depicts an exemplary web page interface displaying an exemplary phase of the user's marketing service transaction;

FIG. 8 depicts an exemplary web page interface displaying an exemplary phase of the user's marketing service transaction;

FIG. 9 depicts an exemplary web page interface displaying an aspect of the user's marketing service transaction using an exemplary all-in-one, multifunctional, moveable menu;

FIG. 10 depicts an exemplary web page interface displaying an aspect of the user's marketing service transaction using an exemplary all-in-one, multifunctional, moveable menu;

FIG. 11 depicts an exemplary web page interface displaying an aspect of the user's marketing service transaction using an exemplary all-in-one, multifunctional, moveable menu;

FIG. 12 depicts an exemplary web page interface displaying an aspect of the user's marketing service transaction using an exemplary all-in-one, multifunctional, moveable menu;

FIG. 13 depicts an exemplary web page interface displaying an aspect of the user's marketing service transaction using an exemplary all-in-one, multifunctional, moveable menu;

FIG. 14 depicts an exemplary web page interface displaying an aspect of the user's marketing service transaction using an exemplary all-in-one, multifunctional, moveable menu;

FIG. 15 depicts an exemplary web page interface displaying an aspect of the user's marketing service transaction using an exemplary all-in-one, multifunctional, moveable menu;

FIG. 16 depicts an exemplary web page interface displaying an aspect of the user's marketing service transaction using an exemplary all-in-one, multifunctional, moveable menu;

FIG. 17 depicts an exemplary web page interface displaying an aspect of the user's marketing service transaction using an exemplary all-in-one, multifunctional, moveable menu;

FIG. 18 is a schematic illustration of an exemplary computing device, in accordance with at least some exemplary embodiments of the present disclosure; and

FIG. 19 is a schematic illustration of an exemplary network, in accordance with at least some exemplary embodiments of the present disclosure.

### DETAILED DESCRIPTION AND INDUSTRIAL APPLICABILITY

The exemplary disclosed apparatus and associated methods relate to a graphical user interface formed based on computer application data and controls configured to correspond with visually perceptible display elements adapted to be graphically manipulated on a computer display, and automatically adapting the form, appearance, and content of the visually perceptible display elements in response to user interaction with the elements. In an illustrative example, the graphical user interface may be an all-in-one, multifunctional, moveable menu. In some embodiments, the visually perceptible display elements may be button groups or menus adapted in response to user interaction with the buttons. For example, in some embodiments, menus, buttons and button groups may be expanded, separated, or freely repositioned in multi-level star patterns to enhance user navigation of the button hierarchy. Various examples may advantageously provide improved website or mobile application navigation based on multifunctional, moveable, and separable menus providing a central access point to application functionality.

In at least some exemplary embodiments, the exemplary disclosed system and method may reduce the effort involved for a user to navigate a web page. This facilitation may be a result of providing graphical user interface menus and buttons that are moveable and expandable in response to user interaction. For example, a user selecting a button or menu item at a top level of a hierarchy may be presented with multiple menus or buttons representing lower levels of the hierarchy. In some embodiments, satisfaction with the user experience may be improved. Such increased user experience approval may be a result of providing a user-customizable graphical user interface layout. In an illustrative example, in various implementations menus or buttons at various hierarchical levels may be separated from a button or menu group, and repositioned to any point on the display page.

Various implementations may enhance user familiarization with web site or application interface topologies or hierarchies. This facilitation may be a result of focusing the user on a central interface access point based on separable, moveable, and expandable menus and buttons. Some embodiments may conserve display page area. Such improved display page area usage efficiency may be a result of multi-function menus that collapse to a single button. Various embodiments may enhance the mobile device application experience. Such improved mobile device user satisfaction may be a result of reduced scrolling or zooming effort by a user to navigate web application functionality. In an illustrative example, in some embodiments a button may be separated from other buttons by a user, and moved to a display page location that may be convenient to access without scrolling or zooming effort by the user.

The details of various embodiments are set forth in the accompanying drawings and the description below. Other features and advantages will be apparent from the description and drawings, and from the claims.

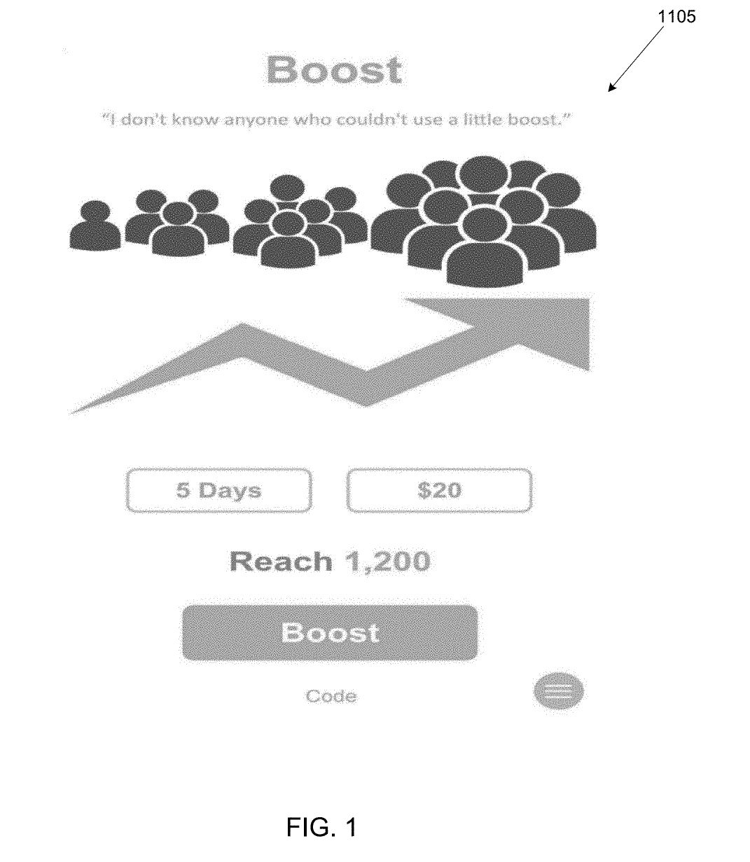

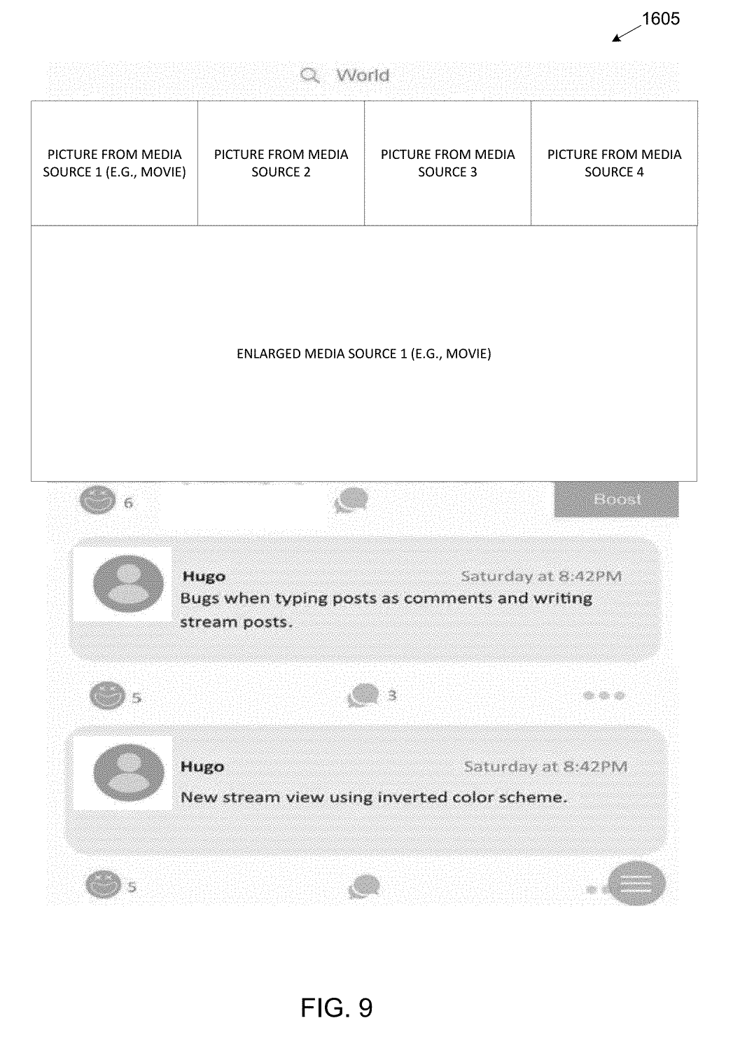

FIGS. 1-17 illustrate numerous exemplary embodiments of the present disclosure. For example, exemplary web pages offering commercial marketing opportunities are briefly introduced with reference to FIGS. 1-8. FIGS. 9-17 illustrate for example exemplary implementations of an all-in-one, multifunctional, moveable menu. Further, exemplary all-in-one, multifunctional, moveable menus are presented to illustrate various graphical user interface design embodiments.

FIG. 1 depicts an exemplary web page interface 1105 to an exemplary web service offering commercial marketing service opportunities. In FIG. 1, the depicted web page may display an exemplary invitation to engage a commercial marketing service offering.

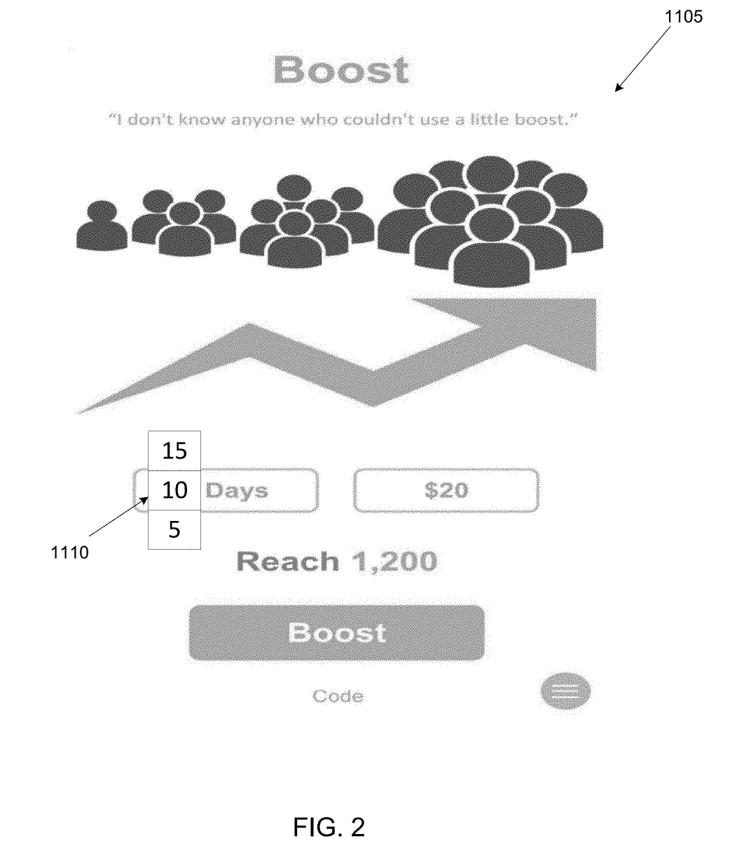

FIG. 2 depicts exemplary web page interface 1105 displaying an exemplary phase of the user's marketing service transaction. In FIG. 2, the user may scroll an item list 1110 to choose parameters of the commercial marketing service transaction. In the depicted embodiment, the item list 1110 parameters may represent the length in days of the offered marketing campaign. In the illustrated embodiment, the monetary cost may be correlated with the reach of the offered marketing campaign. In the depicted embodiment, the reach of the offered marketing campaign may be the number of target market members reached. In the illustrated embodiment for example, the user has selected ten days for the length of the campaign with a reach of twelve-hundred target market members at a cost of twenty dollars.

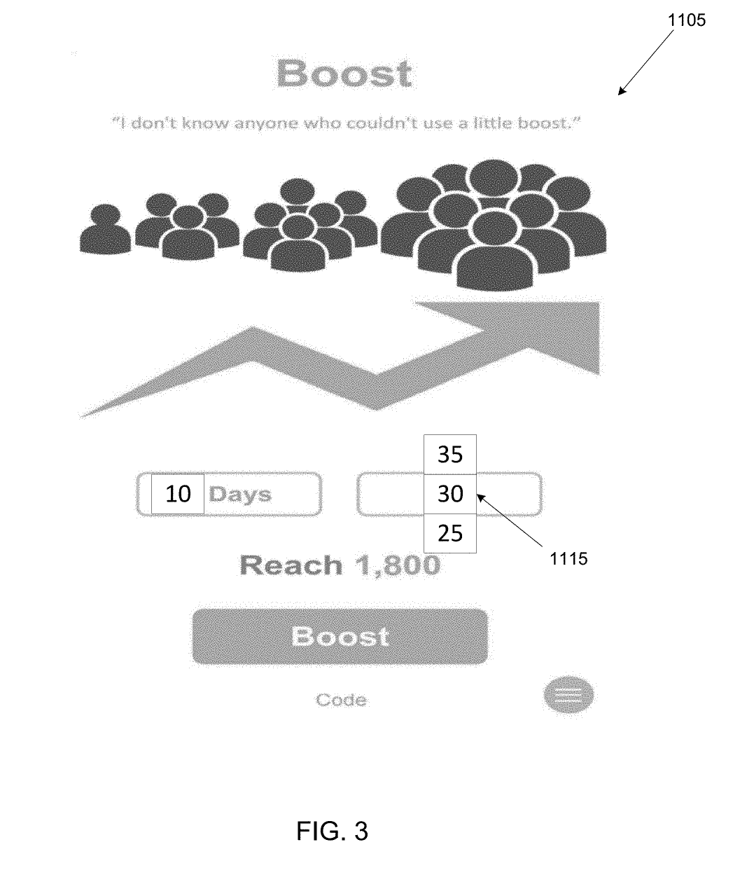

FIG. 3 depicts exemplary web page interface 1105 displaying an exemplary phase of the user's marketing service transaction. In FIG. 3, the user may scroll an item list 1115 to choose parameters of the commercial marketing service transaction. In the depicted embodiment, the item list 1115 parameters may represent the desired monetary cost and reach of the offered marketing campaign. In the illustrated embodiment, the monetary cost may be correlated with the reach of the offered marketing campaign. For example, as a user increases the monetary cost (e.g., and/or the length of time) of the offered marketing campaign, the reach may increase by a proportional amount. Also for example, as a user increases the reach of the offered marketing campaign, the monetary cost may increase by a proportional amount. In the depicted embodiment, the reach of the offered marketing campaign may be the number of target market members reached. In the illustrated embodiment for example, the user may select a cost of thirty dollars for a reach (e.g., a correlated reach) of eighteen-hundred target market members for ten days.

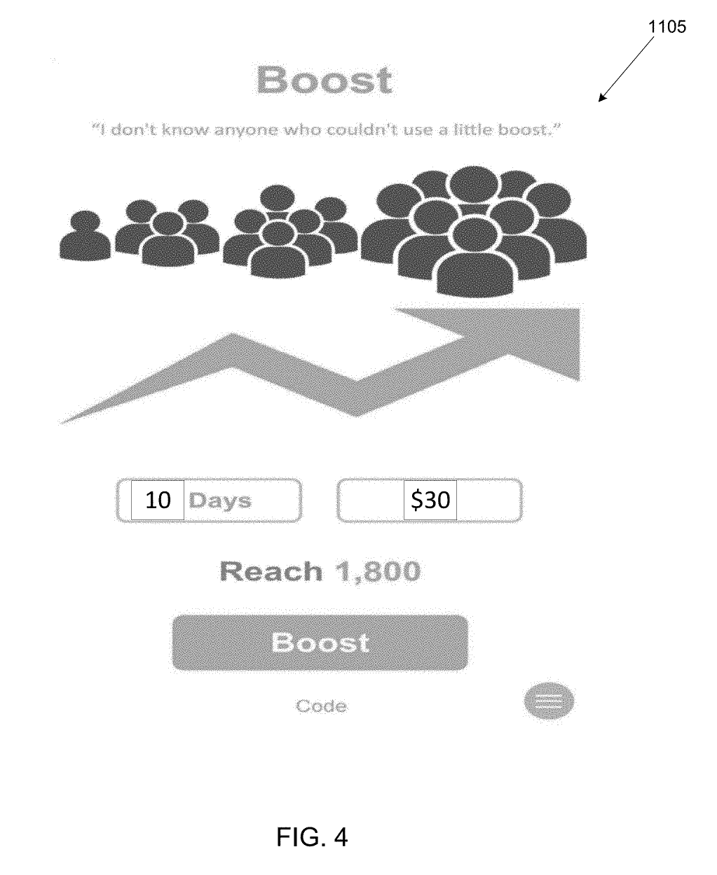

FIG. 4 depicts exemplary web page interface 1105 displaying an exemplary phase of the user's marketing service transaction. In FIG. 4 for example, the web page interface may display a confirmation of the user's selected marketing campaign at a cost of thirty dollars for a reach of eighteen-hundred inbound ad impressions for ten days. In the depicted embodiment, the web page interface may present the user with a button that when selected and clicked by the user may cause the web service to run the selected marketing campaign.

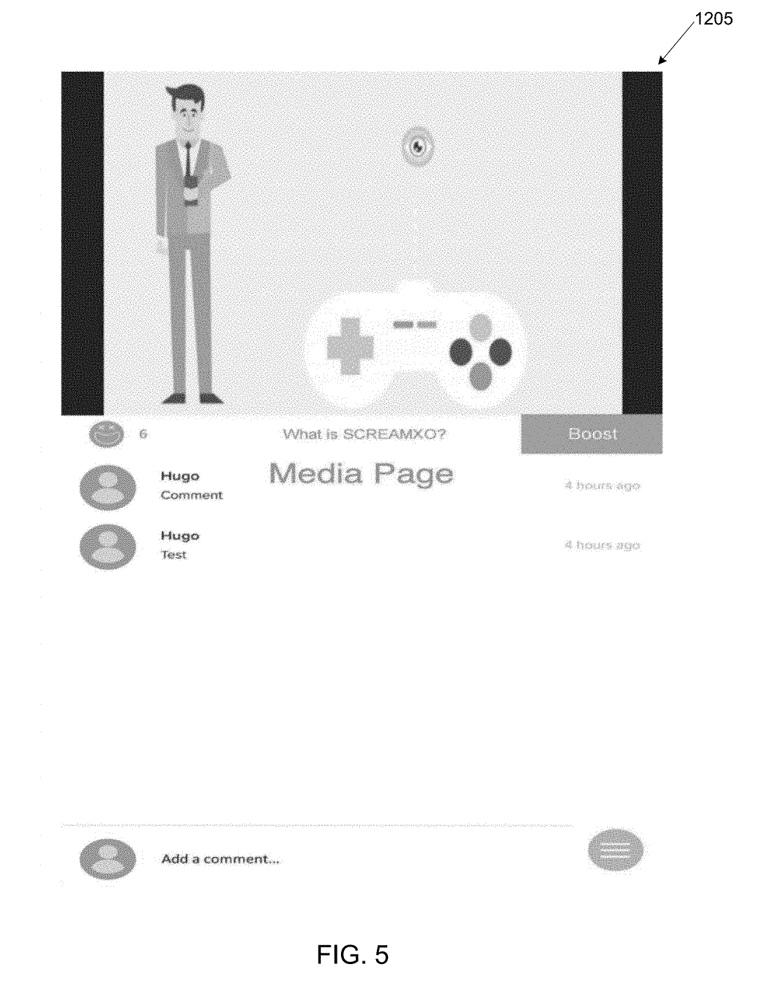

FIG. 5 depicts an exemplary web page interface 1205 displaying an exemplary phase of the user's marketing service transaction. In FIG. 5, the web page interface may display available media content selectable by the user for delivery in the selected marketing campaign.

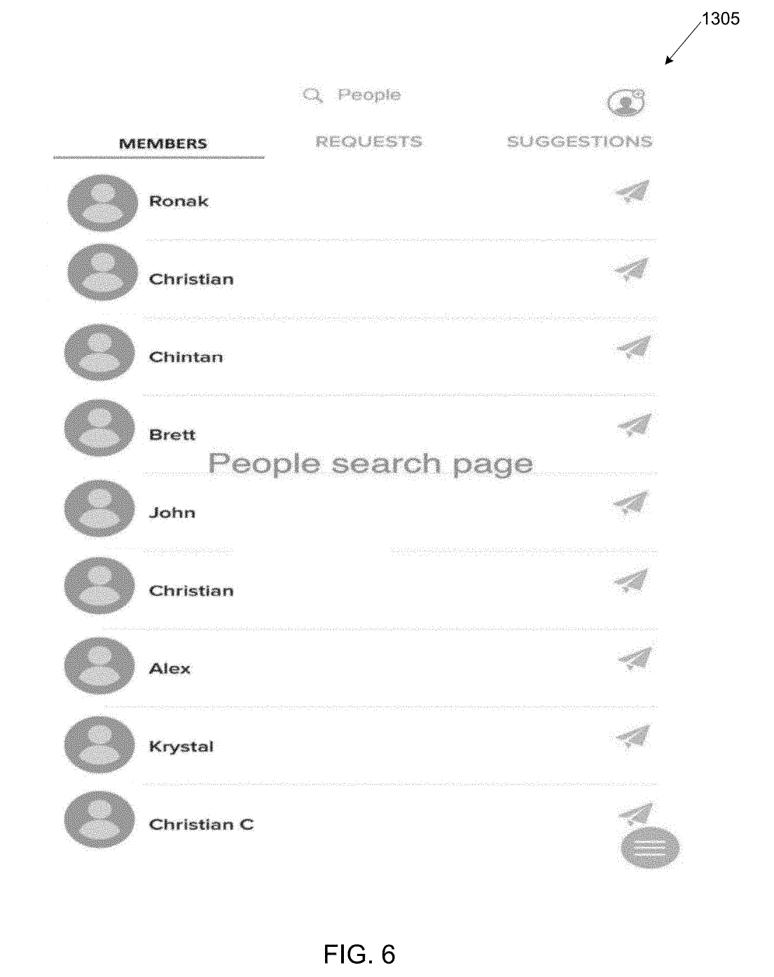

FIG. 6 depicts an exemplary web page interface 1305 displaying an exemplary phase of the user's marketing service transaction. In FIG. 6, the web page interface may display a search page such as a people search page identifying potential recipients selectable by the user for delivery in the selected marketing campaign. In the depicted embodiment, the potential recipients of the marketing campaign may be filtered as a function of the communication status of the user with the potential recipient. In the illustrated embodiment, the potential recipients of the marketing campaign may be filtered based on membership status, whether the potential recipient has issued a request, or whether the potential recipient has submitted a suggestion.

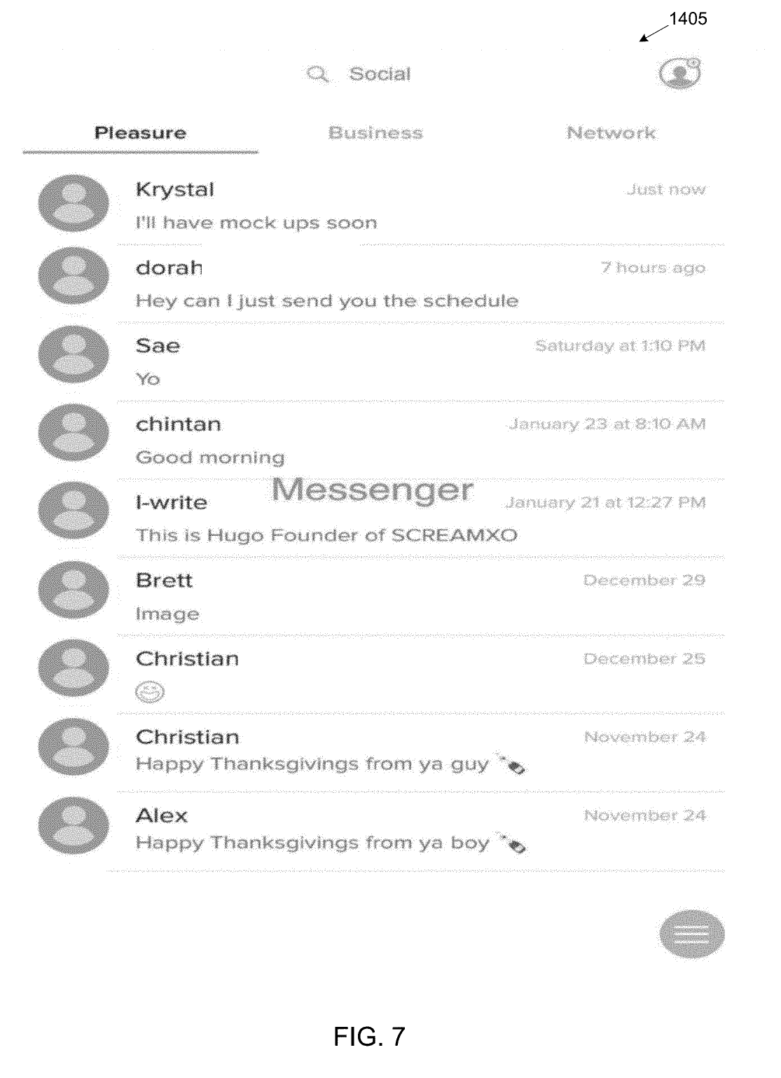

FIG. 7 depicts an exemplary web page interface 1405 displaying an exemplary phase of the user's marketing service transaction. In FIG. 7, exemplary web page interface 1405 may display a message page such as a messenger page identifying potential recipients selectable by the user for delivery in the selected marketing campaign. In the depicted embodiment, the potential recipients of the marketing campaign may be filtered as a function of the relationship type of the user with the potential recipient. In the illustrated embodiment, the potential recipients of the marketing campaign may be filtered based on relationship types including Pleasure, Business, or broader Network relationship circles or groups.

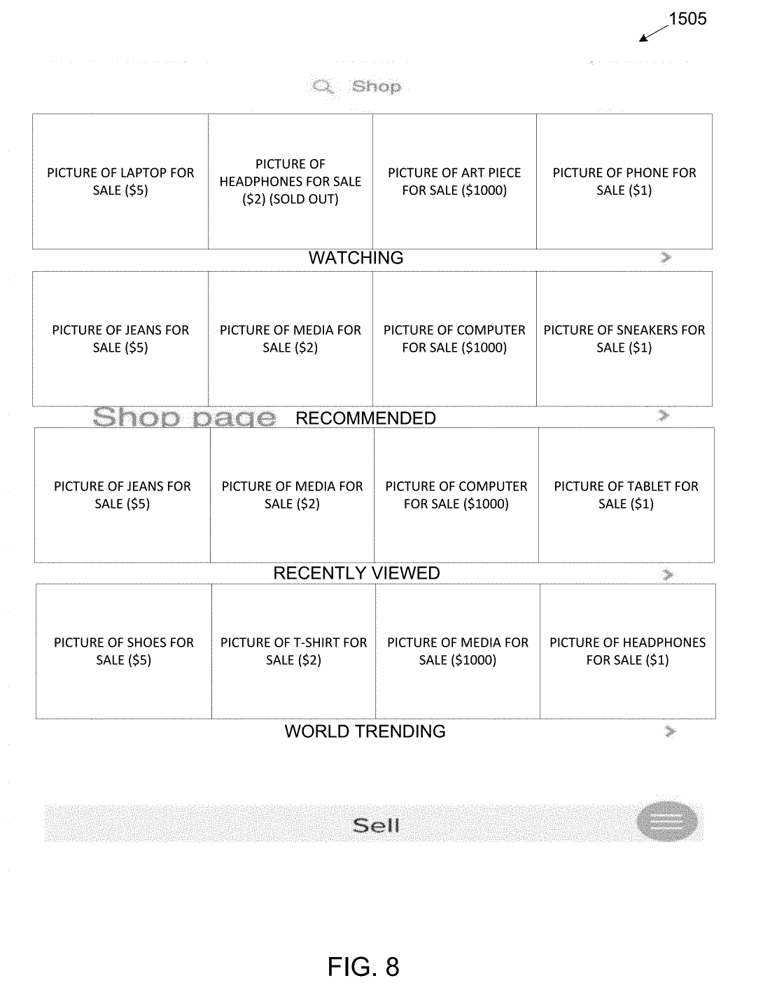

FIG. 8 depicts an exemplary web page interface 1505 displaying an exemplary phase of the user's marketing service transaction. In FIG. 8, exemplary web page interface 1505 may display the Shop page presenting scrollable split-screen multimedia representing marketing content that the marketing recipient is currently watching, content recommended for the marketing recipient, content the marketing recipient has recently viewed, and world trending marketing content. In some embodiments, world trending marketing content may be content that is ranked highest in the number of likes or views requested by various marketing recipients.

FIG. 9 depicts an exemplary web page interface 1605 displaying an aspect of the user's marketing service transaction using an embodiment all-in-one, multifunctional, moveable menu. In FIG. 9, exemplary web page interface 1605 may display a world trending Shop page in an expanded thumbnail view. In the depicted embodiment, the media preview and/or media playback shows an expanded playback window when a thumbnail is clicked.

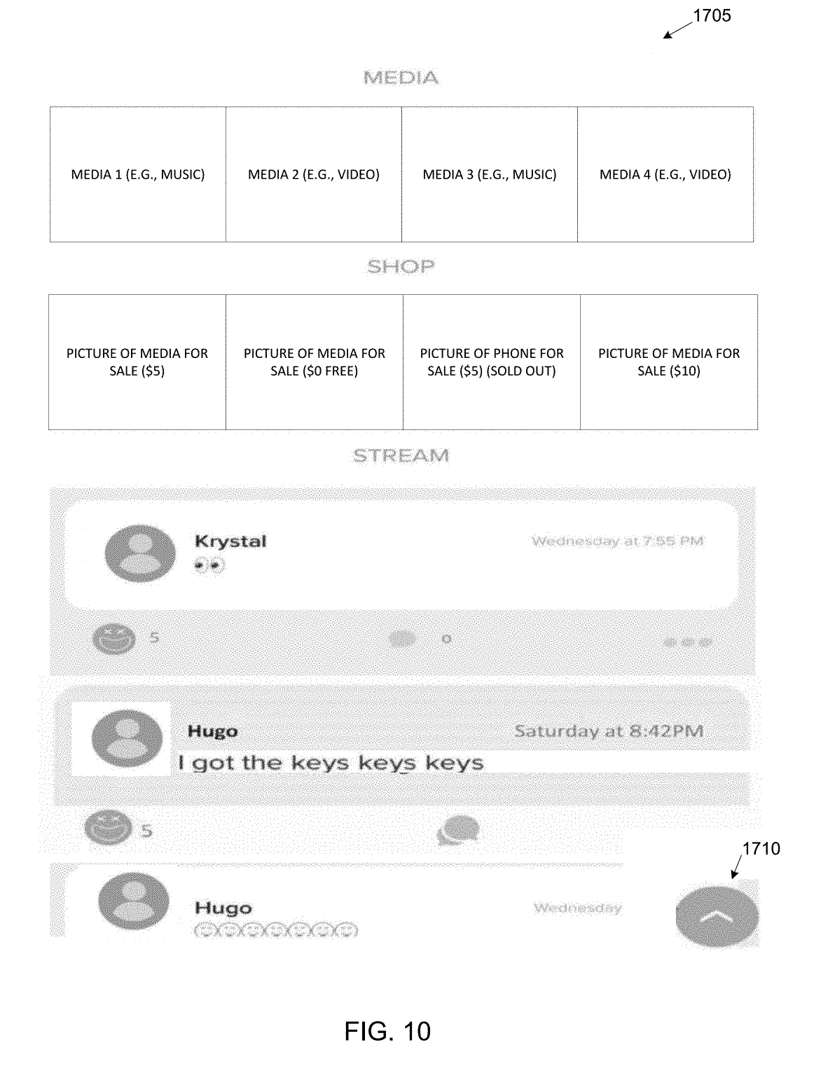

FIG. 10 depicts an exemplary web page interface 1705 displaying an aspect of the user's marketing service transaction using an exemplary all-in-one, multifunctional, moveable menu. In FIG. 10, exemplary web page interface 1705 may display the Stream, Media and Shop page with an exemplary element (e.g., exemplary element 1710 such as a menu button) at the page lower-right. In the depicted embodiment, the menu button changes to a page-up button whenever this page is scrolled downward.

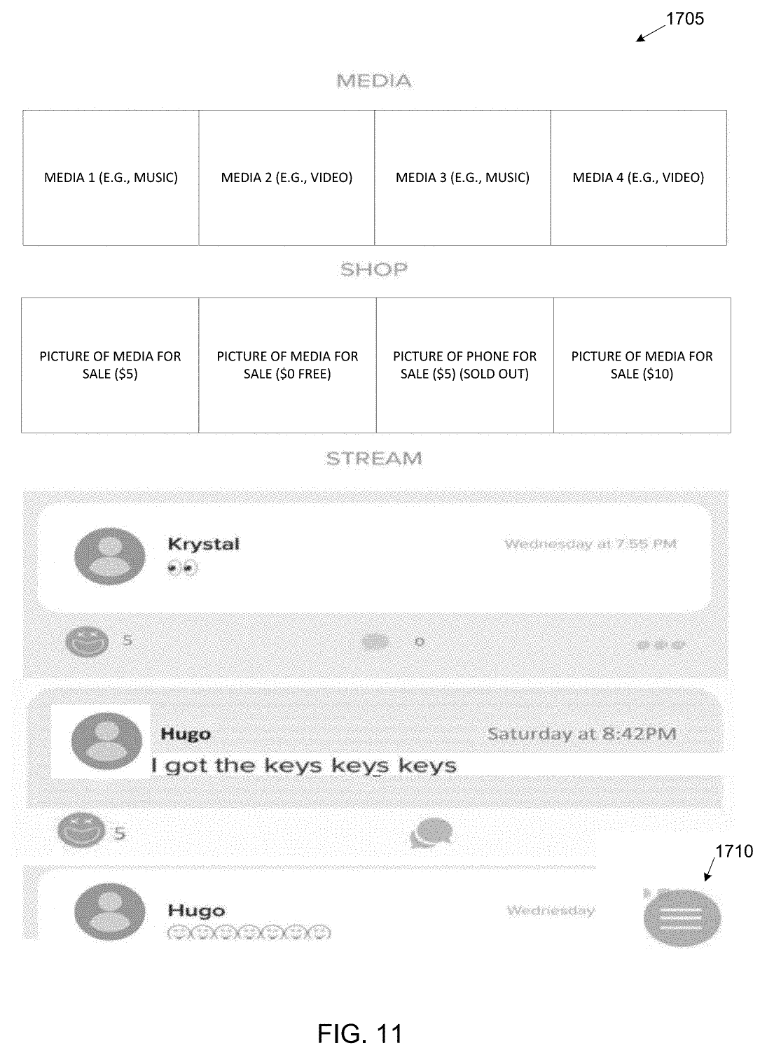

FIG. 11 depicts exemplary web page interface 1705 displaying an aspect of the user's marketing service transaction using element 1710 that may be an exemplary all-in-one, multifunctional, moveable menu. In FIG. 11, exemplary web page interface 1705 may display the Stream, Media and Shop page with exemplary menu button 1710 at the page lower-right. In the depicted embodiment, menu button 1710 appears when the page is scrolled up. In the illustrated embodiment, menu button 1710 may be moveable (e.g., by a user or the exemplary system) to any part of the screen.

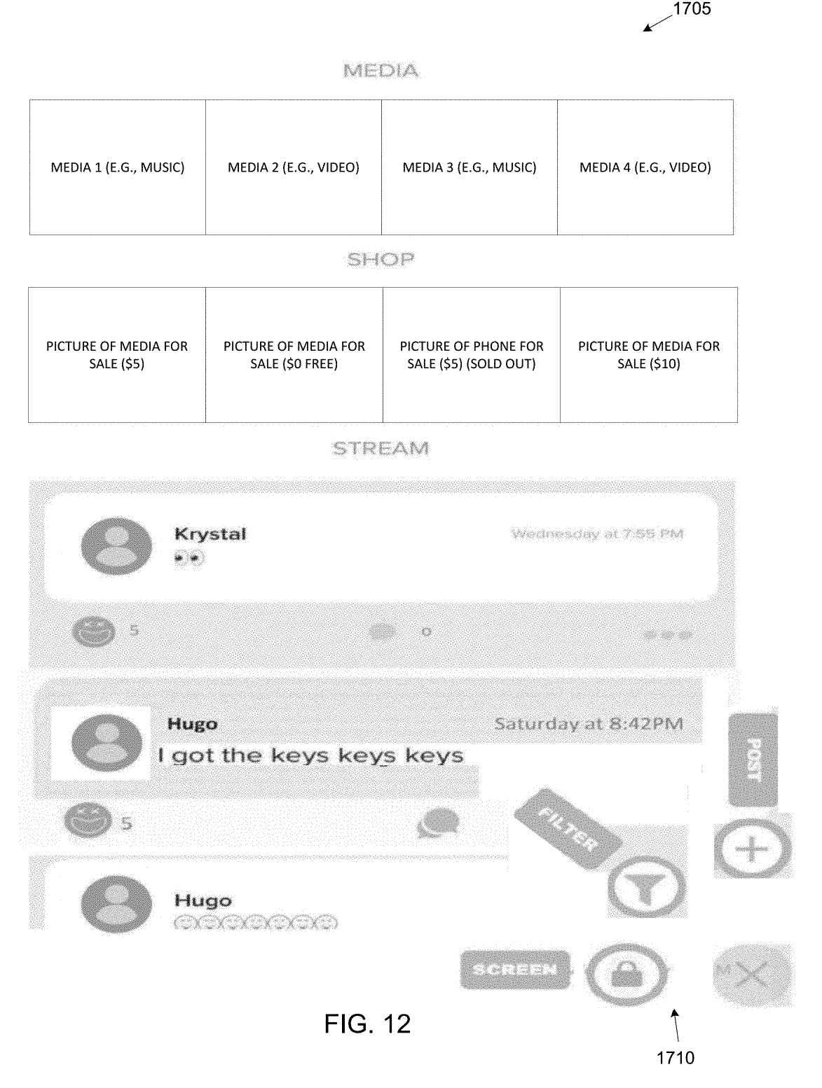

FIG. 12 depicts exemplary web page interface 1705 displaying an aspect of the user's marketing service transaction using exemplary element 1710 that may be an all-in-one, multifunctional, moveable menu. In FIG. 12, web page interface 1705 may display the Stream, Media and Shop page with menu button 1710 at the page lower-right. In the depicted embodiment, when clicked menu button 1710 may show multiple menu icons that may lead to the indicated page. In the illustrated embodiment, in response to receiving a click, menu button 1710 has expanded into a plurality of buttons (e.g., three buttons) disposed in a radial configuration (e.g., with a radial displacement) about the central button in a button group. In an illustrative example, embodiment buttons may be arranged or located on the display page in any spatial or geometric relationship relative to the central button in a button group. In various embodiments, buttons may be placed algorithmically as a function of button size and screen content at the time of placement. In the depicted embodiment, the central button has been supplemented with an ‘x’ button that when clicked may collapse the expanded button to restore the original button from the button group. In the illustrated embodiment, the button group may display a screen button, a filter button, and a post button. In the depicted embodiment, any or all of the central button, the supplemented central button, the button group as a whole, or each, any of, or all of the screen button, filter button, or post button, may be repositioned by the user to any portion of the page display.

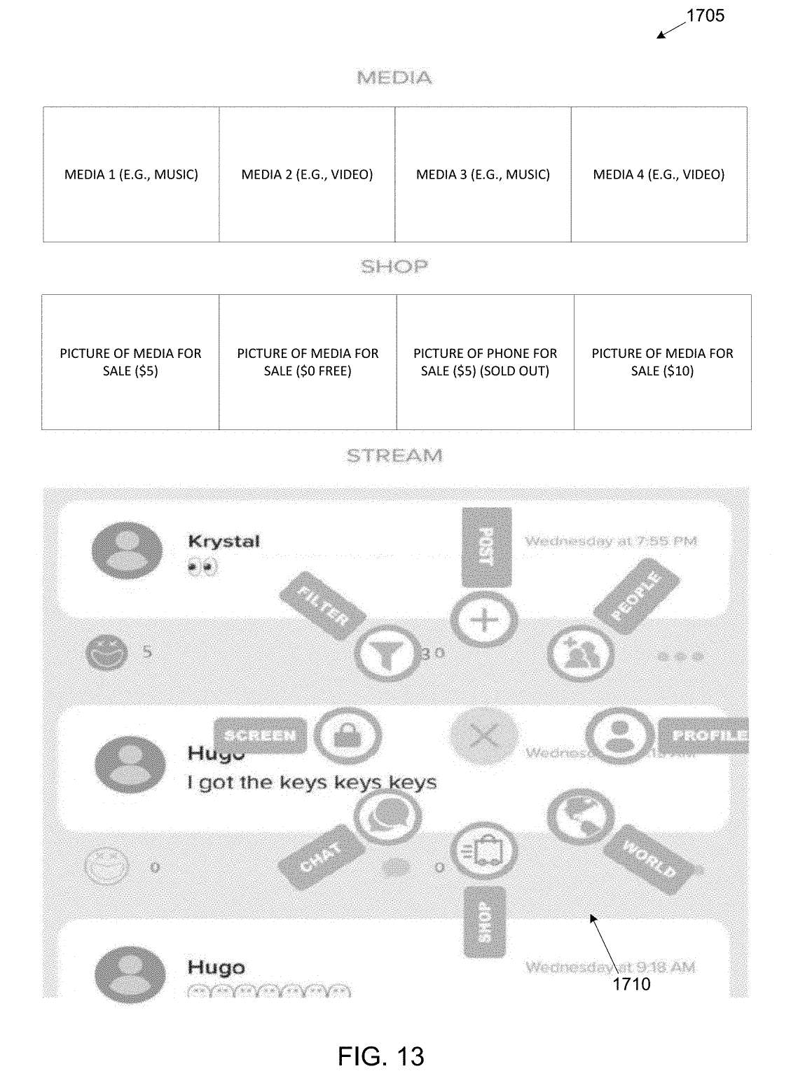

FIG. 13 depicts exemplary web page interface 1705 displaying an aspect of the user's marketing service transaction using element 1710 that may be an exemplary all-in-one, multifunctional, moveable menu. In FIG. 13, exemplary web page interface 1705 may display the Stream, Media and Shop page with an embodiment menu button at the page lower-right. In the depicted embodiment, when clicked the menu button shows multiple menu icons that may lead to the indicated page. In the illustrated embodiment, in response to receiving a click, the menu button has expanded into a plurality of buttons (e.g., eight buttons) disposed with a radial displacement about the central button in a button group. In the depicted embodiment, the menu button has been dragged out of the corner displaying menu icons in a circular or star-like format. In an illustrative example, exemplary buttons may be arranged or located on the display page in any spatial or geometric relationship relative to the central button in a button group. In various embodiments, buttons may be placed algorithmically as a function of button size and screen content at the time of placement. In the depicted embodiment, the central button has been supplemented with an ‘x’ button that when clicked may collapse the expanded button to restore the original button from the button group. In the illustrated embodiment, the button group displays a screen button, a filter button, a post button, a people button, a profile button, a world button, a shop button, and a chat button. In the depicted embodiment, any or all of the central button, the supplemented central button, the button group as a whole, or each, any of, or all of the screen button, filter button, post button, people button, profile button, world button, shop button, or chat button, may be repositioned by the user to any portion of the page display.

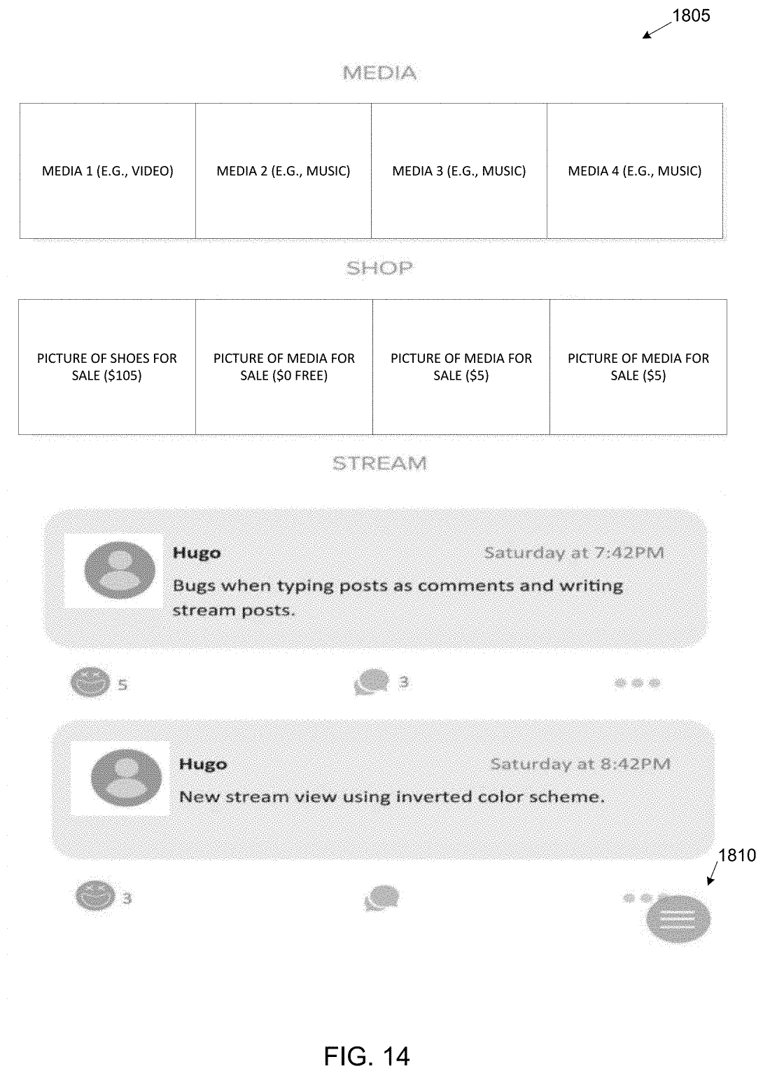

FIG. 14 depicts an exemplary web page interface 1805 displaying an aspect of the user's marketing service transaction using an element 1810 that may be an exemplary all-in-one, multifunctional, moveable menu. In FIG. 14, exemplary web page interface 1805 may display the Stream, Media and Shop page presenting an exemplary dashboard.

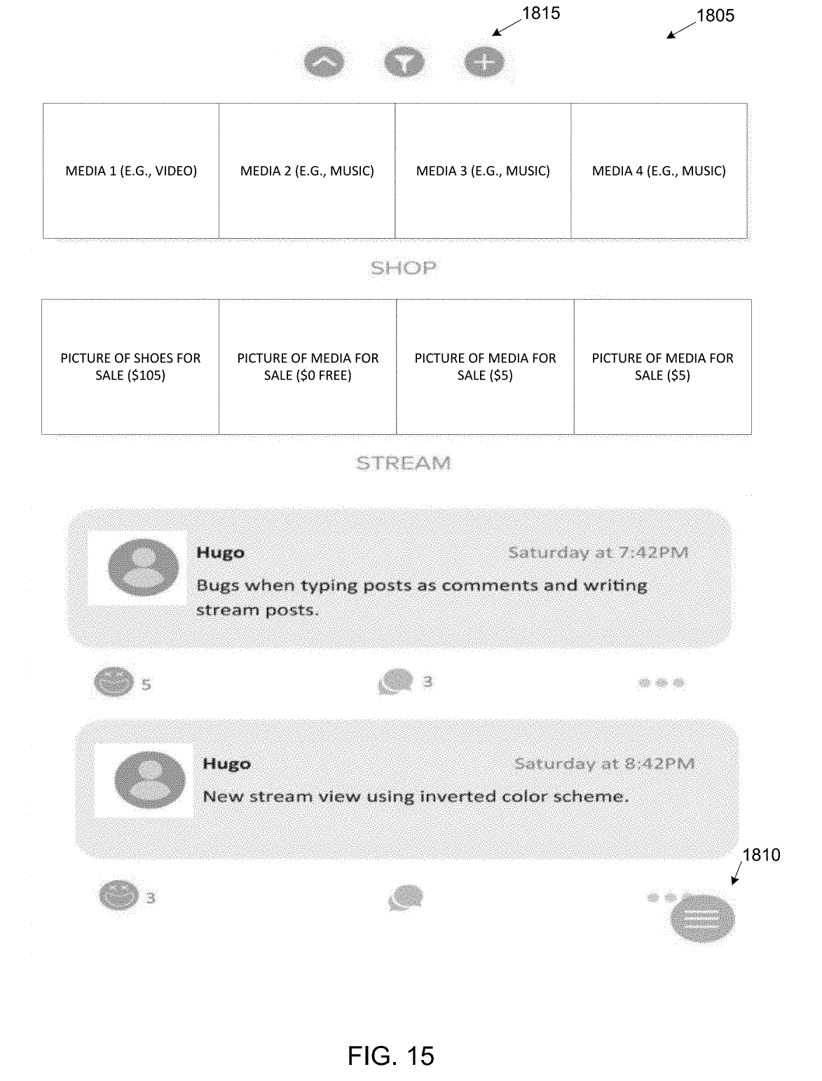

FIG. 15 depicts exemplary web page interface 1805 displaying an aspect of the user's marketing service transaction using element 1810 that may be an all-in-one, multifunctional, moveable menu. In FIG. 15, exemplary web page interface 1805 may display the Stream, Media and Shop page presenting an embodiment dashboard with elements 1815 that may be functional buttons that automatically appear when the Media title is clicked on the dashboard. In the depicted embodiment, clicking on the Media title may automatically display three functional buttons 1815 representing Page-up, Filter, and Add functions.

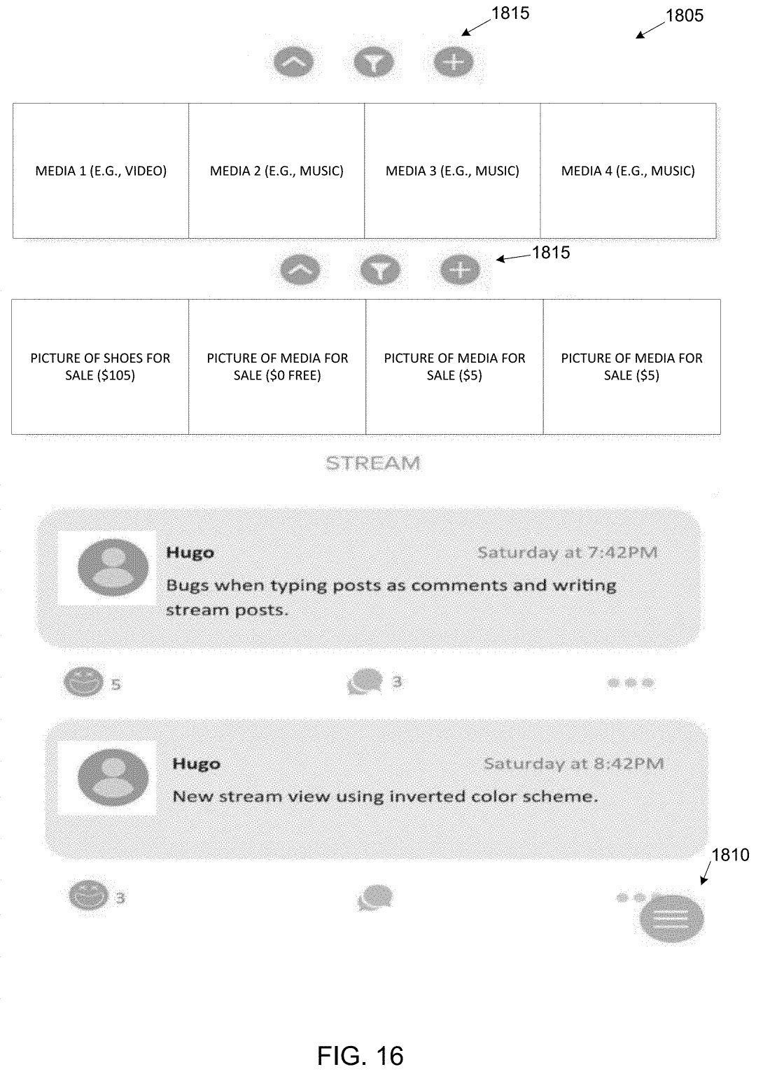

FIG. 16 depicts exemplary web page interface 1805 displaying an aspect of the user's marketing service transaction using element 1810 that may be an all-in-one, multifunctional, moveable menu. In FIG. 16, exemplary web page interface 1805 may display the Stream, Media and Shop page presenting an exemplary dashboard with elements 1815 that may be functional buttons that automatically appear when the Shop title is clicked on the dashboard. In the depicted embodiment, clicking on the Shop title may automatically display three functional buttons 1815 representing Page-up, Filter, and Add functions.

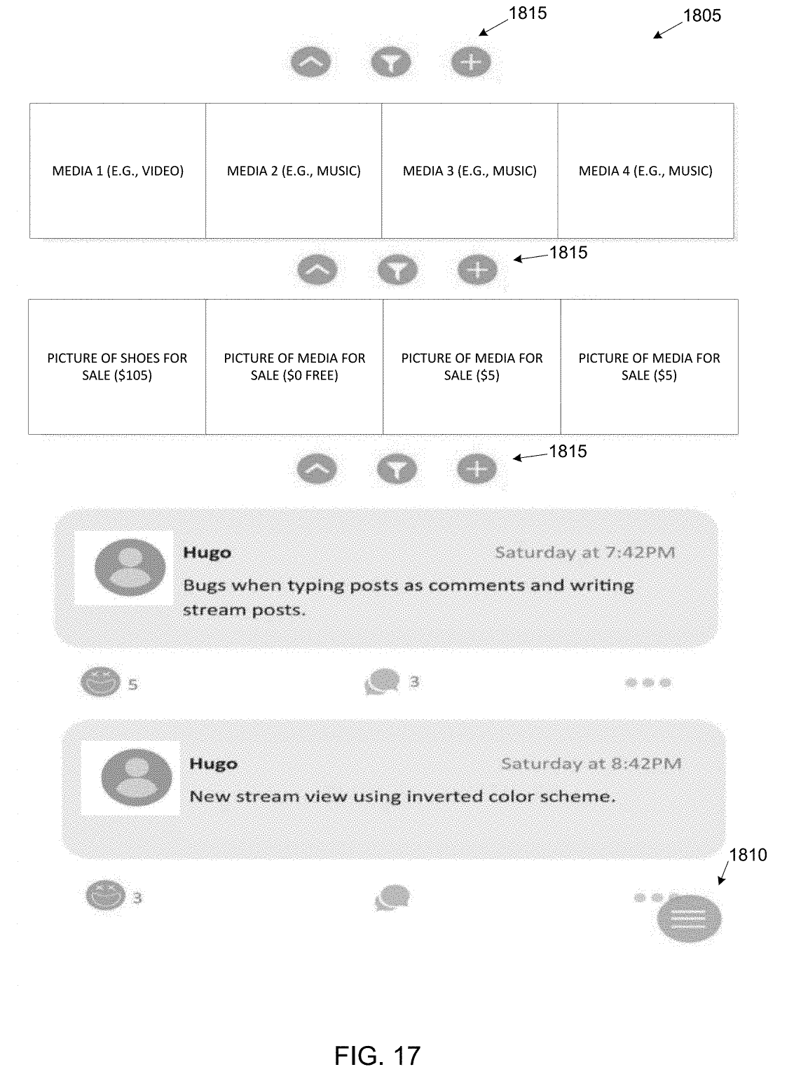

FIG. 17 depicts exemplary web page interface 1805 displaying an aspect of the user's marketing service transaction using element 1810 that may be an all-in-one, multifunctional, moveable menu. In FIG. 17, exemplary web page interface 1805 may display the Stream, Media and Shop page presenting an exemplary dashboard with elements 1815 that may be functional buttons that automatically appear when the Stream title is clicked on the dashboard. In the depicted embodiment, clicking on the Stream title may automatically display three functional buttons 1815 representing Page-up, Settings, and Add functions.

The exemplary disclosed system and method may be used in any suitable application that involves a user interface. For example, the exemplary disclosed system and method may be used to navigate content using any suitable graphical user interface. For example, the exemplary disclosed system and method may be used as part of a user interface of any suitable device for navigating any media or other content such as web content and/or any other desired computing device content.

Although various embodiments have been described with reference to the Figures, other embodiments are possible. For example, some embodiments may include an all-in-one, multifunctional, moveable menu. Various designs may include an all-in-one, multifunctional, moveable button. In some exemplary usage scenarios of various embodiments, an all-in-one, multifunctional, moveable menu or all-in-one, multifunctional, moveable button may simplify mobile application and website navigation and increase functionality. In some embodiments, an embodiment all-in-one, multifunctional, moveable button may double as a ‘page-up’ button. In various implementations, an embodiment all-in-one, multifunctional, moveable button may be moveable to any part of the website or mobile application. In some scenarios, an embodiment all-in-one, multifunctional, moveable menu may use relatively little space on a screen. In various scenarios, an embodiment all-in-one, multifunctional, moveable menu may be multi-functional as a ‘page-up’ button. In some scenarios, an exemplary all-in-one, multifunctional, moveable menu may be multi-functional as a ‘page-down’ button. In some embodiments, an all-in-one, multifunctional, moveable menu may be modular, allowing the menu to be rearrangeable. For example, in various designs, an all-in-one, multifunctional, moveable menu may be formed from rearrangeable modular visually-perceptible user selectable elements. In some embodiments, an all-in-one, multifunctional, moveable menu may improve user experiences. Such increased user experience satisfaction may be a result of some exemplary all-in-one multifunctional, moveable menus improving website or mobile application navigation while simplifying functionality. In an illustrative example, efficient website or mobile application navigation may be a result of embodiment all-in-one, multifunctional, moveable menus providing a central point of access to website or web application functionality. In various designs, a central point of access to website or web application functionality as provided by some exemplary all-in-one, multifunctional, moveable menus may concentrate user focus to functional application elements. In some embodiments, a central point of access to website or web application functionality as provided by some exemplary all-in-one, multifunctional, moveable menus may provide a ‘Center Station’ that cleans and simplifies screens by concentrating user focus to one central point of access.

In at least some exemplary embodiments, the exemplary disclosed system may include a navigation control module, comprising computer-executable code stored in non-volatile memory, a processor, and a graphical user interface having a graphical user interface display. The navigation control module, the graphical user interface, and the processor may be configured to display one or more graphical interactive user interface objects on the graphical user interface display, display a multi-functional control object (e.g., element 1710 or element 1810) on the graphical user interface display, and change the multi-functional control object from a first state to a second state, which may be different from the first state, based on user input provided to the graphical user interface. The multi-functional control object may be moveable on the graphical user interface display based on user input provided to the graphical user interface. The multi-functional control object may be an all-in-one multi-functional control object that controls substantially all user navigation of the one or more graphical interactive user interface objects. The multi-functional control object may be a central point of access to functionality of a website or a web application. The multi-functional control object may include a plurality of modular user-rearrangeable navigation control objects. The first state may be a collapsed state and the second state may be an expanded state. The first state may be an expanded state including a plurality of navigation control objects that control a user navigation of the one or more graphical interactive user interface objects and the second state may be a collapsed state. The plurality of navigation control objects may be a screen button, a filter button, a post button, a people button, a profile button, a world button, a shop button, and/or a chat button. At least one of the first state and the second state may be an expanded state including a plurality of navigation control objects disposed in a radial configuration about a central navigation control object. At least one of the first state and the second state may be an expanded state including a plurality of navigation control objects disposed in a circular configuration about a central navigation control object. The expanded state may collapse into a collapsed state when a user activates the central navigation control object. At least one of the first state and the second state may be a collapsed state including a single menu button that expands into an all-in-one menu including as plurality of buttons when activated by a user.

In at least some exemplary embodiments, the exemplary method may include displaying one or more graphical interactive user interface objects on a graphical user interface display, displaying a multi-functional control object (e.g., element 1710 or element 1810) on the graphical user interface display, changing the multi-functional control object from a first state to a second state, which may be different from the first state, based on user input provided to the graphical user interface, and moving the multi-functional control object on the graphical user interface display based on user input provided to the graphical user interface. The multi-functional control object may be an all-in-one multi-functional control object that controls substantially all user navigation of the one or more graphical interactive user interface objects. The multi-functional control object changes from the first state to the second state that may be a page-up button when the graphical user interface display is scrolled downward. Moving the multi-functional control object may include moving the multi-functional control object to any part of the graphical user interface display. The multi-functional control object may be moved to a corner of the graphical user interface display in the first or second state that is a collapsed state so that a display area of the graphical user interface display is maximized. At least one of the first state and the second state may be a page-up or a page-down button. The multi-functional control object may be disposed at an edge of the graphical user interface display in the first or second state that may be a collapsed state so that a display area of the graphical user interface display is maximized.

In at least some exemplary embodiments, the exemplary control system may include a navigation control module, comprising computer-executable code stored in non-volatile memory, a processor, and a graphical user interface having a graphical user interface display. The navigation control module, the graphical user interface, and the processor may be configured to display one or more graphical interactive user interface objects on the graphical user interface display, display a first multi-functional control object (e.g., element 1710 or element 1810) on the graphical user interface display, change a text object to a second multi-functional control object (e.g., element 1815) on the graphical user interface display based on user input provided to the graphical user interface, and change the first multi-functional control object from a first state to a second state, which may be different from the first state, based on user input provided to the graphical user interface. The first multi-functional control object may be moveable on the graphical user interface display based on user input provided to the graphical user interface. The first multi-functional control object and the second multi-functional control object may provide an all-in-one multi-functional control object array that may control substantially all user navigation of the one or more graphical interactive user interface objects. The first and second multi-functional control objects may provide a central point of access to functionality of a website or a web application. The first multi-functional control object may include a plurality of modular user-rearrangeable navigation control objects. The second multi-functional control object may include a page-up function element, a filter function element, and an add function element.

In at least some exemplary embodiments, the exemplary system and method may include processes for stabilizing a virtual currency and a digital wallet, which may allow users of the exemplary system and method to send money anywhere in the world. Also for example, the exemplary system and method may include a cart system (e.g., cart used for users to make purchases using the system) having a multiple photo-per-item scheme or process that sorts items by sellers. This exemplary feature may allow a user to buy multiple items from multiple different people at the same time or at about the same time.

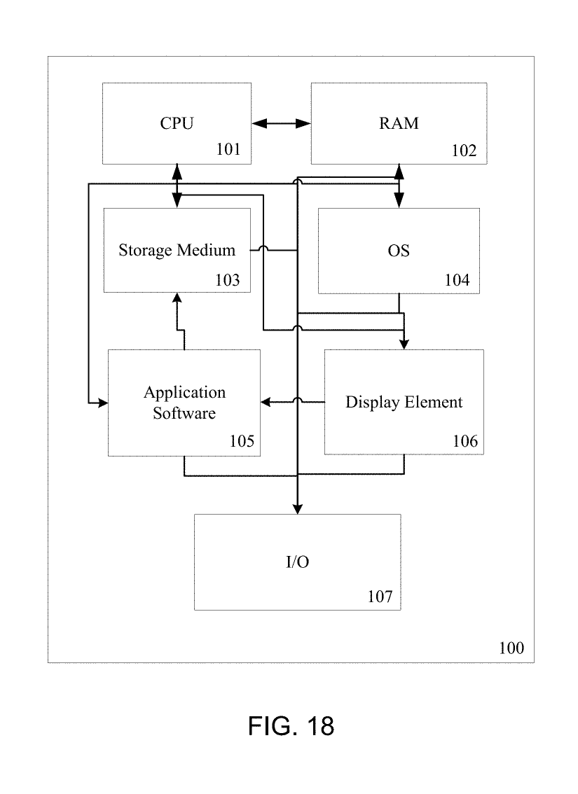

An illustrative representation of a computing device appropriate for use with embodiments of the system of the present disclosure is shown in FIG. 18. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

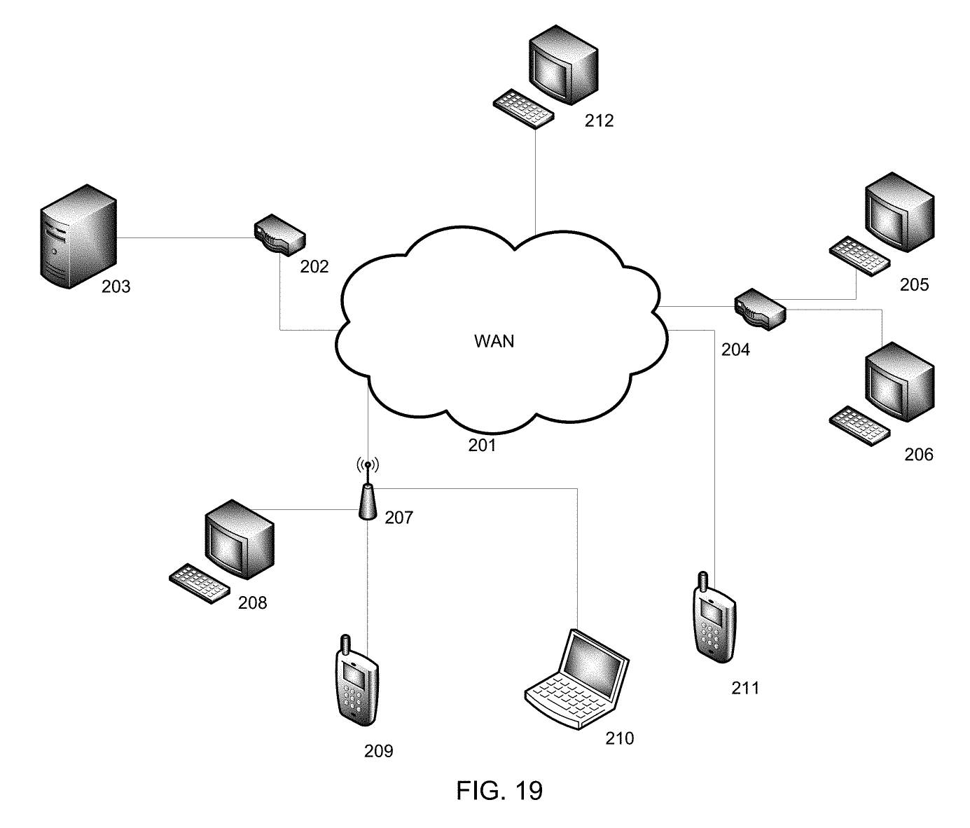

Various examples of such general-purpose multi-unit computer networks suitable for embodiments of the disclosure, their typical configuration and many standardized communication links are well known to one skilled in the art, as explained in more detail and illustrated by FIG. 19, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 19, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 19, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A control system, comprising:
a navigation control module, comprising computer-executable code stored in non-volatile memory;
a processor; and
a graphical user interface having a graphical user interface display;
wherein the navigation control module, the processor, and the graphical user interface are configured to:
display one or more graphical interactive user interface objects on the graphical user interface display;
display a multi-functional control object on the graphical user interface display; and
change the multi-functional control object from a first state to a second state, which is different from the first state, based on user input provided to the graphical user interface;
wherein the multi-functional control object is moveable on the graphical user interface display based on user input provided to the graphical user interface; and
wherein the multi-functional control object is an all-in-one multi-functional control object configured to control substantially all user navigation of the one or more graphical interactive user interface objects.

2. The control system of claim 1, wherein the multi-functional control object is a central point of access to functionality of a website or a web application.

3. The control system of claim 1, wherein the multi-functional control object includes a plurality of modular user-rearrangeable navigation control objects.

4. The control system of claim 1, wherein the first state is a collapsed state and the second state is an expanded state.

5. The control system of claim 1, wherein the first state is an expanded state including a plurality of navigation control objects that control a user navigation of the one or more graphical interactive user interface objects and the second state is a collapsed state.

6. The control system of claim 1, wherein the plurality of navigation control objects are selected from the group consisting of a screen button, a filter button, a post button, a people button, a profile button, a world button, a shop button, and a chat button.

7. The control system of claim 1, wherein at least one of the first state and the second state is an expanded state including a plurality of navigation control objects disposed in a radial configuration about a central navigation control object.

8. The control system of claim 1, wherein at least one of the first state and the second state is an expanded state including a plurality of navigation control objects disposed in a circular configuration about a central navigation control object.

9. The control system of claim 8, wherein the expanded state collapses into a collapsed state when a user activates the central navigation control object.

10. The control system of claim 1, wherein at least one of the first state and the second state is a collapsed state including a single menu button that expands into an all-in-one menu including a plurality of buttons when activated by a user.

11. A method, comprising:
displaying one or more graphical interactive user interface objects on a graphical user interface display;
displaying a multi-functional control object on the graphical user interface display;
changing the multi-functional control object from a first state to a second state, which is different from the first state, based on user input provided to the graphical user interface; and
moving the multi-functional control object on the graphical user interface display based on user input provided to the graphical user interface;
wherein the multi-functional control object is an all-in-one multi-functional control object that controls substantially all user navigation of the one or more graphical interactive user interface objects.

12. The method of claim 11, wherein the multi-functional control object changes from the first state to the second state, which is a page-up button, when the graphical user interface display is scrolled downward.

13. The method of claim 11, wherein moving the multi-functional control object includes moving the multi-functional control object to any part of the graphical user interface display.

14. The method of claim 13, wherein the multi-functional control object is moved to a corner of the graphical user interface display in the first or second state that is a collapsed state so that a display area of the graphical user interface display is maximized.

15. The method of claim 11, wherein at least one of the first state and the second state is a page-up or a page-down button.

16. The method of claim 11, wherein the multi-functional control object is disposed at an edge of the graphical user interface display in the first or second state that is a collapsed state so that a display area of the graphical user interface display is maximized.

17. A control system, comprising:
a navigation control module, comprising computer-executable code stored in non-volatile memory;
a processor; and
a graphical user interface having a graphical user interface display;
wherein the navigation control module, the processor, and the graphical user interface are configured to:
display one or more graphical interactive user interface objects on the graphical user interface display;
display a first multi-functional control object on the graphical user interface display;
change one of the one or more graphical interactive user interface objects to a second multi-functional control object on the graphical user interface display based on user input provided to the graphical user interface; and
change the first multi-functional control object from a first state to a second state, which is different from the first state, based on user input provided to the graphical user interface;
wherein the first multi-functional control object is moveable on the graphical user interface display based on user input provided to the graphical user interface; and
wherein the first multi-functional control object and the second multi-functional control object provide an all-in-one multi-functional control object array that controls substantially all user navigation of the one or more graphical interactive user interface objects.

18. The control system of claim 17, wherein the first and second multi-functional control objects provide a central point of access to functionality of a website or a web application.

19. The control system of claim 17, wherein the first multi-functional control object includes a plurality of modular user-rearrangeable navigation control objects.

20. The control system of claim 17, wherein the second multi-functional control object includes a page-up function element, a filter function element, and an add function element.
